(19) United States
(12) Patent Application Publication
(10) Pub. No.: US 2023/0409775 A1
(43) Pub. Date: Dec. 21, 2023

(54) SYSTEM AND METHOD FOR PERFORMING DEFORMATION AND STRESS ANALYSIS MODELING IN A VIRTUAL FABRICATION ENVIRONMENT

(71) Applicant: Coventor, Inc., Cary, NC (US)

(72) Inventors: Gonzalo Feijoo, Wellesley, MA (US); Yiguang Yan, Newton, MA (US); Daniel Faken, Peabody, MA (US); Kenneth B. Greiner, Arlington, MA (US)

(21) Appl. No.: 18/030,701

(22) PCT Filed: Oct. 14, 2021
(86) PCT No.: PCT/US2021/054977

§ 371 Date: Apr. 6, 2023

Related U.S. Application Data
(60) Provisional application No. 63/091,822, filed on Oct. 14, 2020.

(51) Int. Cl. G06F 30/20; G06T 15/08

(52) U.S. Cl. CPC G06F 30/20; G06T 15/08

(57) ABSTRACT

Embodiments of the present invention provide the ability to perform deformation and stress analysis modeling in a virtual fabrication environment. More particularly, embodiments enable the virtual fabrication environment to model deformation and stress analysis directly from a voxel-based model without requiring generation of an interface conforming mesh. Stress fields for semiconductor device structures may be determined at designated points in the process sequence used to fabricate the semiconductor device.

### RELATED APPLICATION

This application claims priority to U.S. Provisional Patent Application No. 63/091,822, filed Oct. 14, 2020, the entire content of which is incorporated herein by reference in its entirety.

### BACKGROUND

Semiconductor development organizations at integrated device manufacturers (IDMs) and independent foundries spend significant resources developing the integrated sequence of process operations used to fabricate the chips (integrated circuits (ICs)) they sell from wafers (“wafers” are thin slices of semiconductor material, frequently, but not always, composed of silicon crystal). A large portion of the resources is spent on fabricating experimental wafers and associated measurement, metrology (“metrology” refers to specialized types of measurements conducted in the semiconductor industry) and characterization structures, all for the purpose of ensuring that the integrated process produces the desired semiconductor device structures. These experimental wafers are used in a trial-and-error scheme to develop individual processes for the fabrication of a device structure and also to develop the total, integrated process flow. Due to the increasing complexity of advanced technology node process flows, a large portion of the experimental fabrication runs result in negative or null characterization results. These experimental runs are long in duration, weeks to months in the “fab” (fabrication environment), and expensive. Recent semiconductor technology advances, including FinFET, TriGate, High-K/Metal-Gate, embedded memories and advanced patterning, have dramatically increased the complexity of integrated semiconductor fabrication processes. The cost and duration of technology development using this trial-and-error experimental methodology has concurrently increased.

A virtual fabrication environment for semiconductor device structures offers a platform for performing semiconductor process development at a lower cost and higher speed than is possible with conventional trial-and-error physical experimentation. In contrast to conventional CAD and TCAD environments, a virtual fabrication environment is capable of virtually modeling an integrated process flow and predicting the complete 3D structures of all devices and circuits that comprise a full technology suite. Virtual fabrication can be described in its most simple form as combining a description of an integrated process sequence with a subject design, in the form of 2D design data (masks or layout), and producing a 3D structural model that is predictive of the result expected from a real/physical fabrication run. A 3D structural model includes the geometrically accurate 3D shapes of multiple layers of materials, implants, diffusions, etc. that comprise a chip or a portion of a chip. Virtual fabrication is done in a way that is primarily geometric, however the geometry involved is instructed by the physics of the fabrication processes. By performing the modeling at the structural level of abstraction (rather than physics-based simulations), construction of the structural models can be dramatically accelerated, enabling full technology modeling, at a circuit-level area scale. The use of a virtual fabrication environment thus provides fast verification of process assumptions, and visualization of the complex interrelationship between the integrated process sequence and the 2D design data.

### BRIEF SUMMARY

Embodiments of the present invention provide the ability to perform deformation and stress analysis modeling in a virtual fabrication environment. More particularly, embodiments enable the virtual fabrication environment to model deformation and stress analysis directly from a voxel-based model without requiring generation of an interface conforming mesh. Stress fields for semiconductor device structures may be determined at designated points in the process sequence used to fabricate the semiconductor device. In some embodiments, the stress field may be evolved over a sequence of process steps with the stress field for each step taking into account the stress field resulting from the previous step.

In one embodiment, a computing device-implemented for performing deformation and stress analysis modeling in a virtual fabrication environment includes the step of receiving a selection of a process sequence in a process editor for a semiconductor device structure to be virtually fabricated, the process sequence including a user-specified deformation and stress analysis modeling step. The deformation and stress analysis modeling step indicates a point during the process sequence for deformation and stress analysis modeling to be performed. The method further performs with the computing device a virtual fabrication run that models an integrated process flow used to physically fabricate the semiconductor device structure by using the process sequence and 2D design data to simulate patterning, material addition and/or material removal steps performed to physically fabricate the semiconductor device structure. The virtual fabrication run executes the process sequence up until the deformation and stress analysis modeling step and builds a 3D structural model of the semiconductor device structure. The 3D structural model is a voxel-based model that uses an implicit geometry representation that includes a plurality of voxels arranged in a voxel grid and is predictive of a result of a physical fabrication of the semiconductor device structure. The virtual fabrication run further performs the deformation and stress analysis modeling and generates result data. The method additionally includes outputting the result data generated from the deformation and stress analysis modeling step.

In another embodiment, a system for performing deformation and stress analysis modeling in a virtual fabrication environment includes at least one computing device equipped with one or more processors that is configured to generate a virtual fabrication environment. The virtual fabrication environment includes a deformation and stress analysis modeling module. The deformation and stress analysis modeling module when executing receives a selection of a process sequence in a process editor for a semiconductor device structure to be virtually fabricated. The process sequence includes a user-specified deformation and stress analysis modeling step that indicates a point during the process sequence for deformation and stress analysis modeling to be performed. The deformation and stress analysis modeling module when executed further performs with the computing device a virtual fabrication run that models an integrated process flow used to physically fabricate the semiconductor device structure by using the process sequence and 2D design data to simulate patterning, material addition and/or material removal steps performed to physically fabricate the semiconductor device structure. The virtual fabrication run executes the process sequence up until the deformation and stress analysis modeling step. The executing of the process sequence builds a 3D structural model of the semiconductor device structure. The 3D structural model is a voxel-based model that uses an implicit geometry representation that includes a plurality of voxels arranged in a voxel grid and is predictive of a result of a physical fabrication of the semiconductor device structure. The virtual fabrication run further performs the deformation and stress analysis modeling step and generates result data. The system further includes a display in communication with the at least one computing device that is configured to display the result data from the deformation and stress analysis step.

### BRIEF DESCRIPTION OF THE DRAWINGS

The accompanying drawings, which are incorporated in and constitute a part of this specification, illustrate one or more embodiments of the invention and, together with the description, help to explain the invention. In the drawings:

FIG. 1 depicts an exemplary virtual fabrication environment suitable for practicing an embodiment of the present invention;

FIG. 2 depicts an exemplary virtual fabrication console provided by the virtual fabrication environment;

FIG. 3 depicts an exemplary layout editor provided by the virtual fabrication environment;

FIG. 4 depicts an exemplary process editor provided by the virtual fabrication environment;

FIG. 5 depicts an exemplary 3D viewer provided by the virtual fabrication environment;

FIG. 6 depicts an exemplary sequence of steps performed in the virtual fabrication environment to set up and perform a virtual experiment generating virtual metrology measurement data for multiple semiconductor device structure models;

FIG. 7 depicts an exemplary parameter explorer view used to provide process parameters for a virtual experiment provided by the virtual fabrication environment;

FIG. 8 depicts an exemplary tabular-formatted display of virtual metrology data generated in a virtual experiment provided by the virtual fabrication environment;

FIG. 9 depicts an exemplary graphical display of virtual metrology data generated in a virtual experiment provided by the virtual fabrication environment;

FIG. 10A depicts exemplary voxel-based representations of a circle boundary;

FIG. 10B depicts exemplary staircasing effects addressed by adjusting voxel size;

FIG. 11A (prior art) depicts a conformal mesh generated from a 3D structural model of an STI feature;

FIG. 11B depicts a stress analysis model produced from a voxel grid;

FIG. 12 depicts a sequence of steps performed in the virtual fabrication environment to perform deformation and stress analysis modeling in an exemplary embodiment;

FIG. 13 depicts a graphical user interface displaying the results of a stress analysis step in an exemplary embodiment.

FIGS. 14A-14C depict exemplary graphical user interfaces for inserting deformation and stress analysis steps into a process sequence in exemplary embodiments;

FIGS. 15A-15K depict exemplary graphical user interfaces provided by the virtual fabrication environment depicting the evolution of stress fields for an STI feature of interest in an exemplary embodiment; and

FIG. 16 depicts side by side views of a single stress analysis result and an evolved stress field after the final spacer step for fabrication of the STI feature in exemplary embodiments.

### DETAILED DESCRIPTION

Embodiments of the present invention provide a virtual fabrication environment enabling deformation and stress analysis modeling as part of a process sequence. However, prior to discussing the deformation and stress analysis modeling provided by embodiments in greater detail, an exemplary 3D virtual fabrication environment which may be utilized to practice the embodiments is first described.

Exemplary Virtual Fabrication Environment

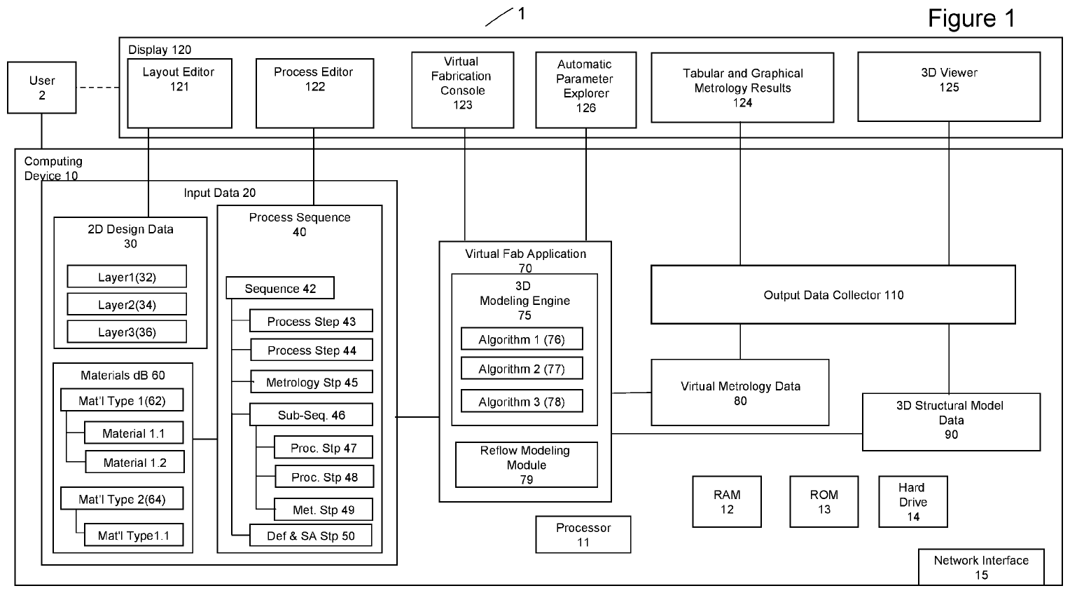

FIG. 1 depicts an exemplary virtual fabrication environment 1 suitable for practicing an embodiment of the present invention. Virtual fabrication environment 1 includes a computing device 10 accessed by a user 2. Computing device 10 is in communication with a display 120. Display 120 may be a display screen that is part of computing device 10 or may be a separate display device or display surface in communication with computing device 10. Computing device 10 may be a PC, laptop computer, tablet computing device, server, or some other type of computing device equipped with a processor 11 and able to support the operations of 3D modeling engine 75 (described further below). The processor may have one or more cores. The computing device 10 may also include volatile and non-volatile storage such as, but not limited to, Random Access Memory (RAM) 12, Read Only Memory (ROM) 13 and hard drive 14. Computing device 10 may also be equipped with a network interface 15 so as to enable communication with other computing devices.

Computing device 10 may store and execute virtual fabrication application 70 including 3D modeling engine 75. 3D modeling engine 75 may include one or more algorithms such as algorithm 1 (76), algorithm 2 (77), and algorithm 3 (78) used in virtually fabricating semiconductor device structures. Virtual fabrication application 70 may also include deformation and stress analysis modeling module 79 containing executable instructions for modeling deformation and stress analysis operations. 3D modeling engine 75 may accept input data 20 in order to perform virtual fabrication “runs” that produce semiconductor device structural model data 90. Virtual fabrication application 70 and 3D modeling engine 75 may generate a number of user interfaces and views used to create and display the results of virtual fabrication runs. For example, virtual fabrication application 70 and 3D modeling engine 75 may display layout editor 121, process editor 122 and virtual fabrication console 123 used to create virtual fabrication runs. Virtual fabrication application 70 and 3D modeling engine 75 may also display a tabular and graphical metrology results view 124 and 3D view 125 for respectively displaying results of virtual fabrication runs and 3D structural models generated by the 3D modeling engine 75 during virtual fabrication of semiconductor device structures.

Input data 20 includes both 2D design data 30 and process sequence 40. Process sequence 40 may be composed of multiple process steps 43, 44, 47 and 48. As described further herein, process sequence 40 may also include one or more virtual metrology measurement process steps 45 and 49. Process sequence 40 may further include one or more subsequences 46 which include one or more of the process steps or virtual metrology measurement process steps. 2D design data 30 includes of one or more layers such as layer 1 (32), layer 2 (34) and layer 3 (36), typically provided in an industry-standard layout format such as GDS II (Graphical Design System version 2) or OASIS (Open Artwork System Interchange Standard).

Input data 20 may also include a materials database 60 including records of material types such as material type 1 (62) and material type 2 (64) and specific materials for each material type. Many of the process steps in a process sequence may refer to one or more materials in the materials database. Each material has a name and some attributes such as a rendering color. The materials database may be stored in a separate data structure. The materials database may have hierarchy, where materials may be grouped by types and sub-types. Individual steps in the process sequence may refer to an individual material or a parent material type. The hierarchy in the materials database enables a process sequence referencing the materials database to be modified more easily. For example, in virtual fabrication of a semiconductor device structure, multiple types of oxide material may be added to the structural model during the course of a process sequence. After a particular oxide is added, subsequent steps may alter that material. If there is no hierarchy in the materials database and a step that adds a new type of oxide material is inserted in an existing process sequence, all subsequent steps that may affect oxide materials must also be modified to include the new type of oxide material. With a materials database that supports hierarchy, steps that operate on a certain class of materials such as oxides may refer only to the parent type rather than a list of materials of the same type. Then, if a step that adds a new type of oxide material is inserted in a process sequence, there is no need to modify subsequent steps that refer only to the oxide parent type. Thus hierarchical materials make the process sequence more resilient to modifications. A further benefit of hierarchical materials is that stock process steps and sequences that refer only to parent material types can be created and re-used.

3D Modeling Engine 75 uses input data 20 to perform the sequence of operations/steps specified by process sequence 40. As explained further below, process sequence 40 may include one or more virtual metrology steps 45, 49 that indicate a point in the process sequence during a virtual fabrication run at which a measurement of a structural component should be taken. The measurement may be taken using a locator shape previously added to a layer in the 2D design data 30. In an alternative embodiment the measurement location may be specified by alternate means such as (x, y) coordinates in the 2D design data or some other means of specifying a location in the 2D design data 30 instead of through the use of a locator shape. Process sequence may also include one or more deformation and stress analysis modeling steps 50 that indicate a point in the process sequence during a virtual fabrication run at which a deformation modeling and/or stress analysis modeling operation should be performed. The performance of the process sequence 40 during a virtual fabrication run generates virtual metrology data 80 and 3D structural model data 90. 3D structural model data 90 may be used to generate a 3D view of the structural model of the semiconductor device structure which may be displayed in the 3D viewer 125. Virtual metrology data 80 may be processed and presented to a user 2 in the tabular and graphical metrology results view 124.

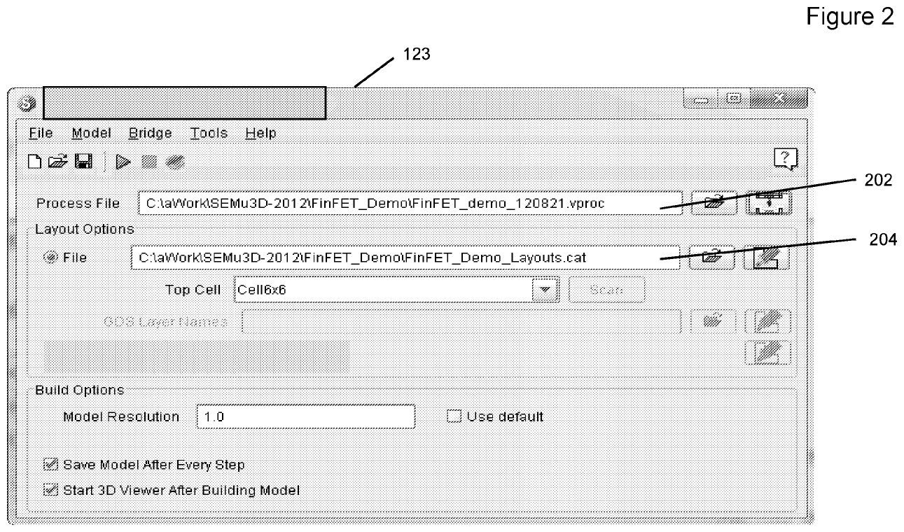

FIG. 2 depicts an exemplary virtual fabrication console 123 provided by the virtual fabrication environment to set up a virtual fabrication run. The virtual fabrication console 123 allows the user to specify a process sequence 202 and the layout (2D design data) 204 for the semiconductor device structure that is being virtually fabricated. It should be appreciated however that the virtual fabrication console can also be a text-based scripting console that provides the user with a means of entering scripting commands that specify the required input and initiate building of a structural model, or building a set of structural models corresponding to a range of parameter values for specific steps in the process sequence. The latter case is considered a virtual experiment (discussed further below).

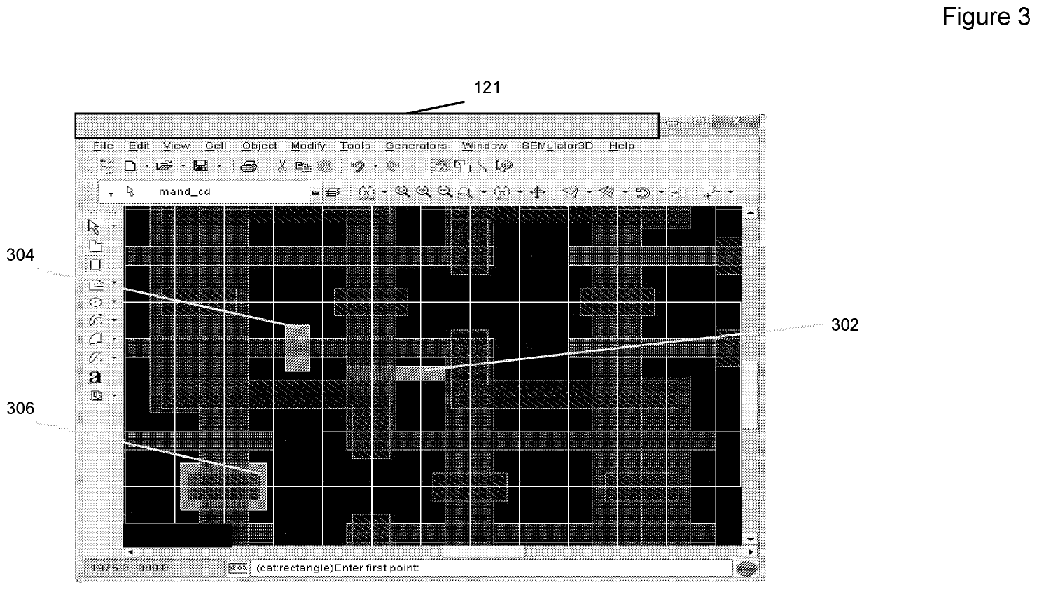

FIG. 3 depicts an exemplary layout editor provided by the virtual fabrication environment. The layout editor 121 displays the 2D design layout specified by the user in the virtual fabrication console 123. In the layout editor, color may be used to depict different layers in the design data. The areas enclosed by shapes or polygons on each layer represent regions where a photoresist coating on a wafer may be either exposed to light or protected from light during a photolithography step in the integrated process flow. The shapes on one or more layers may be combined (Boolean operation) to form a mask that is used in a photolithography step. The layout editor 121 provides a means of inserting, deleting and modifying a polygon on any layer, and of inserting, deleting or modifying layers within the 2D design data. A layer can be inserted for the sole purpose of containing shapes or polygons that indicate the locations of virtual metrology measurements. The rectangular shapes 302, 304, 306 have been added to an inserted layer (indicated by a different color) and mark the locations of virtual metrology measurements. As noted above, other approaches to specifying the locations for the virtual metrology measurements besides the use of locator shapes should also be considered within the scope of the present invention. The design data is used in combination with the process data and materials database to build a 3D structural model.

Inserted layers in the design data displayed in the layout editor 121 may include inserted locator shapes. For example, a locator shape may be a rectangle, the longer sides of which indicate the direction of the measurement in the 3D structural model. For example, in FIG. 3, a first locator shape 302 may mark a double patterning mandrel for virtual metrology measurement, a second locator shape 304 may mark a gate stack for virtual metrology measurement and a third locator shape 306 may mark a transistor source or drain contact for virtual metrology measurement

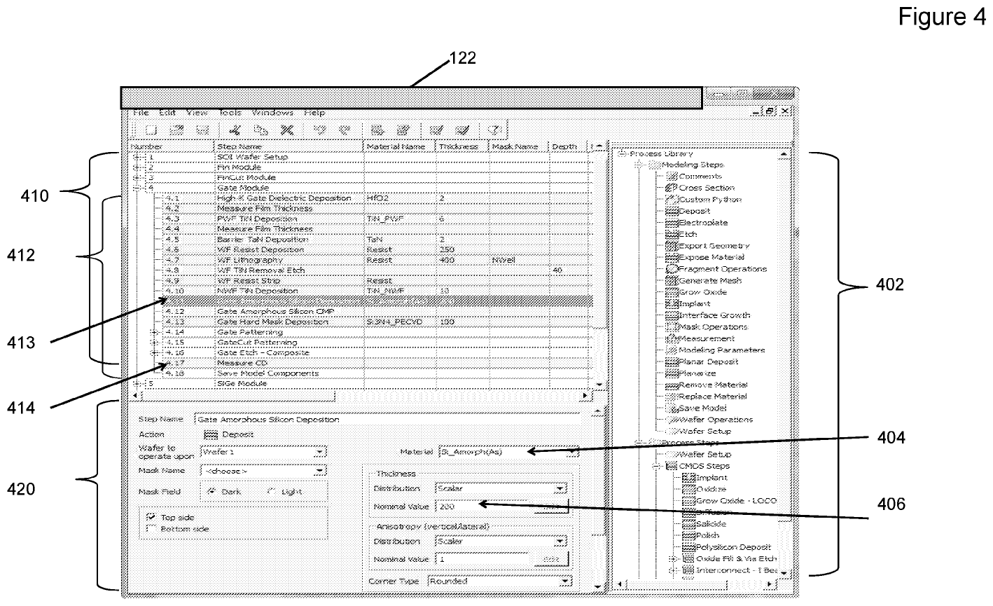

FIG. 4 depicts an exemplary process editor 122 provided by the virtual fabrication environment. The user defines a process sequence in the process editor. The process sequence is an ordered list of process steps conducted in order to virtually fabricate the user's selected structure. The process editor may be a text editor, such that each line or group of lines corresponds to a process step, or a specialized graphical user interface such as is depicted in FIG. 4. The process sequence may be hierarchical, meaning process steps may be grouped into sub-sequences and sub-sequences of sub-sequences, etc. Generally, each step in the process sequence corresponds to an actual step in the fab. For instance, a sub-sequence for a reactive ion etch operation might include the steps of spinning on photo resist, patterning the resist, and performing the etch operation. The user specifies parameters for each step or sub-step that are appropriate to the operation type. Some of the parameters are references to materials in the materials database and layers in the 2D design data. For example, the parameters for a deposit operation primitive are the material being deposited, the nominal thickness of the deposit and the anisotropy or ratio of growth in the lateral direction versus the vertical direction. This deposit operation primitive can be used to model actual processes such as chemical vapor deposition (CVD). Similarly, the parameters for an etch operation primitive are a mask name (from the design data), a list of materials affected by the operation, and the anisotropy.

There may be hundreds of steps in the process sequence and the process sequence may include sub-sequences. For example, as depicted in FIG. 4, a process sequence 410 may include a subsequence 412 made up of multiple process steps such as selected step 413. The process steps may be selected from a library of available process steps 402. For the selected step 413, the process editor 122 enables a user to specify all required parameters 420. For example, a user may be able to select a material from a list of materials in the material database 404 and specify a process parameter 406 for the material's use in the process step 413.

One or more steps in the process sequence may be virtual metrology steps inserted by a user. For example, the insertion of step 4.17 “Measure CD” (414), where CD denotes a critical dimension, in process sequence 412 would cause a virtual metrology measurement to be taken at that point in the virtual fabrication run using one or more locator shapes that had been previously inserted on one or more layers in the 2D design data. By inserting the virtual metrology steps directly in the fabrication sequence, the embodiment of the present invention allows virtual metrology measurements to be taken at critical points of interest during the fabrication process. As the many steps in the virtual fabrication interact in the creation of the final structure, the ability to determine geometric properties of a structure, such as cross-section dimensions and surface area, at different points in the integrated process flow is of great interest to the process developer and structure designer.

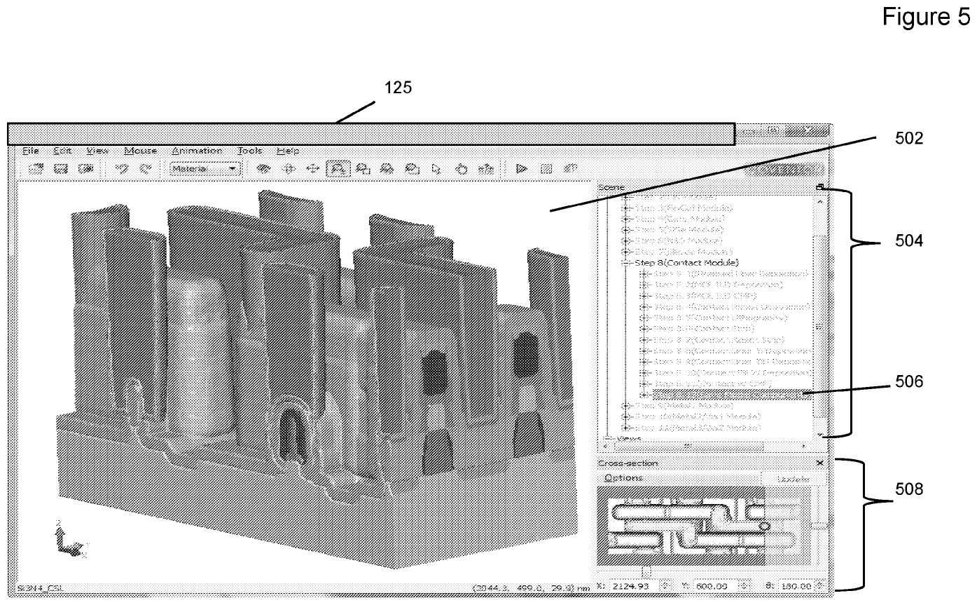

FIG. 5 depicts an exemplary 3D viewer 125 provided by the virtual fabrication environment. The 3D viewer 125 may include a 3D view canvas 502 for displaying 3D models generated by the 3D modeling engine 75. The 3D viewer 125 may display saved states 504 in the process sequence and allow a particular state to be selected 506 and appear in the 3D view canvas. 3D Viewer 125 provides functionality such as zoom in/out, rotation, translation, cross section, etc. Optionally, the user may activate a cross section view in the 3D view canvas 502 and manipulate the location of the cross section using a miniature top view 508.

While building a single structural model can be valuable, there is increased value in virtual fabrication that builds a large number of models. The virtual fabrication environment enables a user to create and run a virtual experiment. In a virtual experiment of the present invention, a range of values of process parameters can be explored. A virtual experiment may be set up by specifying a set of parameter values to be applied to individual processes (rather than a single value per parameter) in the full process sequence. A single process sequence or multiple process sequences can be specified this way. The 3D modeling engine 75, executing in virtual experiment mode, then builds multiple models spanning the process parameter set, all the while utilizing the virtual metrology measurement operations described above to extract metrology measurement data for each variation. This capability provided by the embodiments of the present invention may be used to mimic two fundamental types of experiments that are typically performed in the physical fab environment. Firstly, fabrication processes vary naturally in a stochastic (non-deterministic) fashion. As explained herein, embodiments of the present invention use a fundamentally deterministic approach for each virtual fabrication run that nevertheless can predict statistical results by conducting multiple runs. The virtual experiment mode provided by an embodiment of the present invention allows the virtual fabrication environment to model through the entire statistical range of variation for each process parameter, and the combination of variations in many/all process parameters. Secondly, experiments run in the physical fab may specify a set of parameters to be intentionally varied when fabricating different wafers. The virtual experiment mode of the present invention enables the Virtual Fabrication Environment to mimic this type of experiment as well, by performing multiple virtual fabrication runs on the specific variations of a parameter set.

Each process in the fabrication sequence has its own inherent variation. To understand the effect of all the aggregated process variations in a complex flow is quite difficult, especially when factoring in the statistical probabilities of the combinations of variations. Once a virtual experiment is created, the process sequence is essentially described by the combination of numerical process parameters included in the process description. Each of these parameters can be characterized by its total variation (in terms of standard deviation or sigma values), and therefore by multiple points on a Gaussian distribution or other appropriate probability distribution. If the virtual experiment is designed and executed to examine all of the combinations of the process variations (multiple points on each Gaussian, for example the ±3 sigma, ±2 sigma, ±1 sigma, and nominal values of each parameter), then the resulting graphical and numerical outputs from virtual metrology steps in the sequence cover the total variation space of the technology. Even though each case in this experimental study is modeled deterministically by the virtual fabrication system, the aggregation of the virtual metrology results contains a statistical distribution. Simple statistical analysis, such as Root Sum Squares (RSS) calculation of the statistically uncorrelated parameters, can be used to attribute a total variation metric to each case of the experiment. Then, all of the virtual metrology output, both numerical and graphical, can be analyzed relative to the total variation metric.

In typical trial-and-error experimental practice in a physical fab, a structural measurement resulting from the nominal process is targeted, and process variations are accounted for by specifying an overly large (conservative) margin for the total variation in the structural measurement (total structural margin) which must be anticipated in subsequent processes. In contrast, the virtual experiment embodiments of the present invention can provide quantitative predictions of the total variation envelope for a structural measurement at any point in the integrated process flow. The total variation envelope, rather than the nominal value, of the structural measurement may then become the development target. This approach can ensure acceptable total structural margin throughout the integrated process flow, without sacrificing critical structural design goals. This approach, of targeting total variation may result in a nominal intermediate or final structure that is less optimal (or less aesthetically pleasing) than the nominal structure that would have been produced by targeting the nominal process. However, this sub-optimal nominal process is not critical, since the envelope of total process variation has been accounted for and is more important in determining the robustness and yield of the integrated process flow. This approach is a paradigm shift in semiconductor technology development, from an emphasis on the nominal process to an emphasis on the envelope of total process variation.

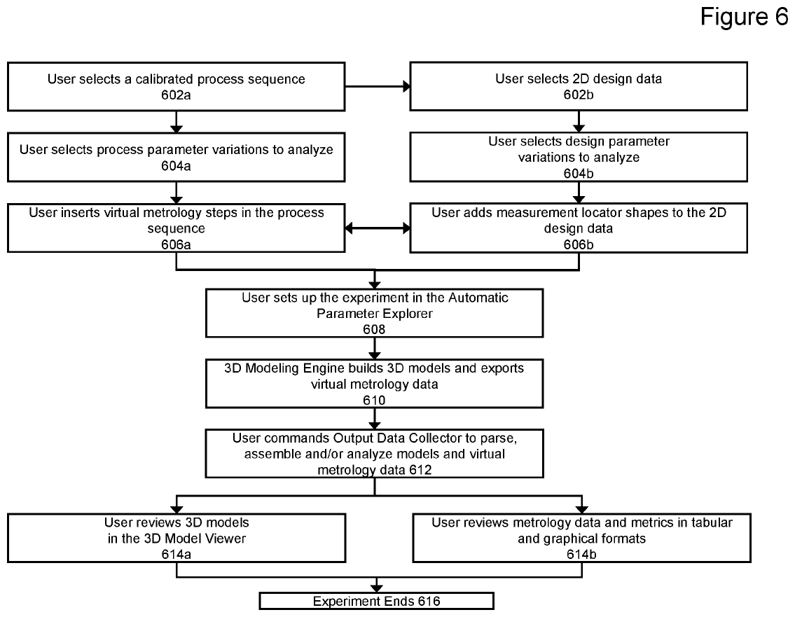

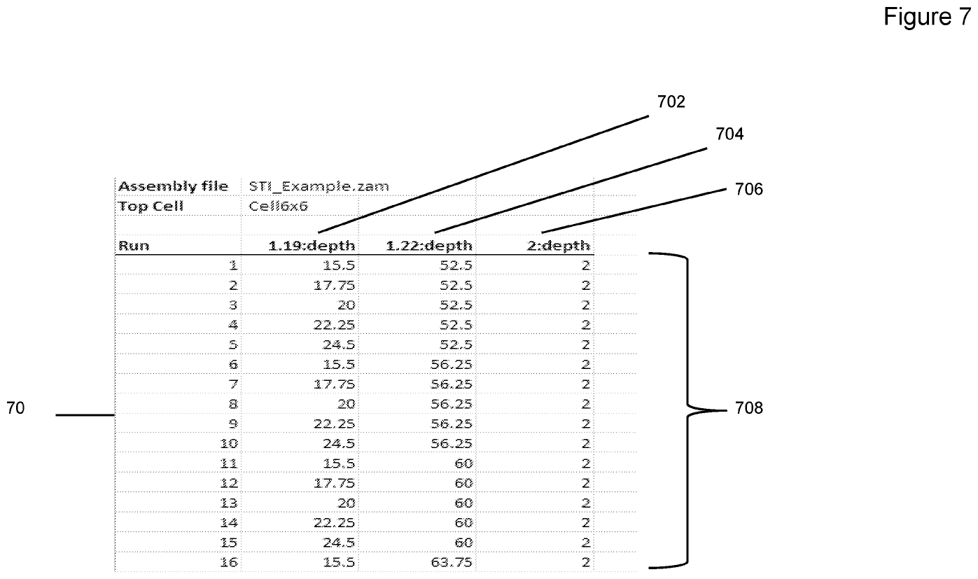

FIG. 6 depicts an exemplary sequence of steps that may be performed in the virtual fabrication environment to set up and perform a virtual experiment generating virtual metrology measurement data for multiple semiconductor device structural models. The sequence begins with a user selecting a process sequence (which may have been previously calibrated to make the results more structurally predictive (step 602a) and identifying/creating 2D design data (step 602b). The user may select process parameter variations to analyze (step 604a) and/or design parameter variations to analyze (step 604b). The user inserts one or more virtual metrology steps in the process sequence as set forth above (step 606a) and adds measurement locator shapes to the 2D design data (step 606b). The user may set up the virtual experiment with the aid of a specialized user interface, an automatic parameter explorer 126 (step 608). An exemplary automatic parameter explorer is depicted in FIG. 7 and may display, and allow the user to vary, the process parameters to be varied 702, 704, 706 and the list of 3D models to be built with their corresponding different parameter values 708. The parameter ranges for a virtual experiment can be specified in a tabular format. The 3D modeling engine 75 builds the 3D models and exports the virtual metrology measurement data for review (step 610). The virtual experiment mode provides output data handling from all Virtual Measurement/Metrology operations. The output data from the virtual metrology measurements may be parsed and assembled into a useful form (step 612).

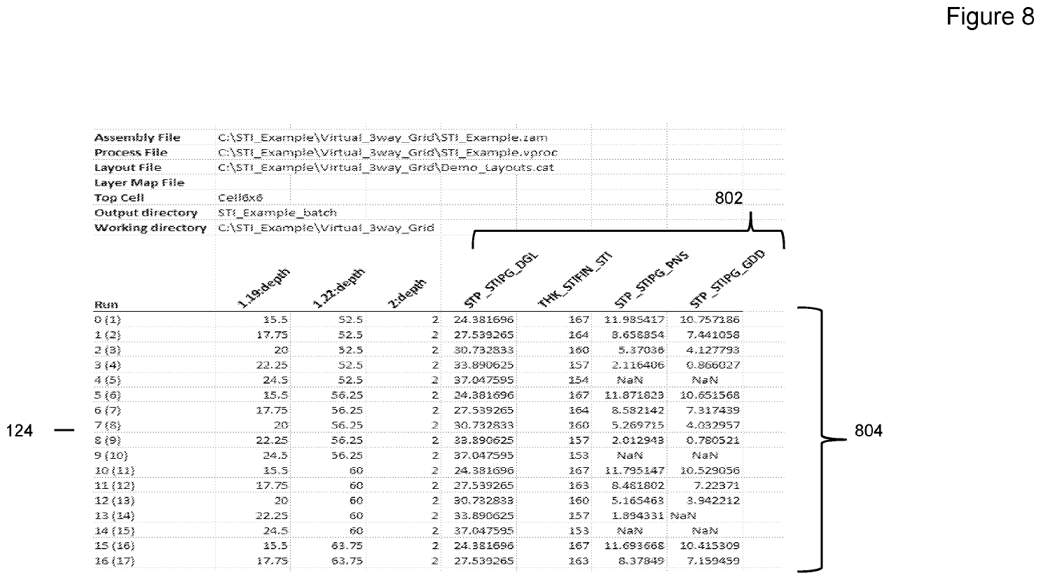

With this parsing and assembling, subsequent quantitative and statistical analysis can be conducted. A separate output data collector module 110 may be used to collect 3D model data and virtual metrology measurement results from the sequence of virtual fabrication runs that comprise the virtual experiment and present them in graphical and tabular formats. FIG. 8 depicts an exemplary tabular-formatted display of virtual metrology data generated by a virtual experiment. In the tabular formatted display, the virtual metrology data collected during the virtual experiment 802 and the list of virtual fabrication runs 804 may be displayed.

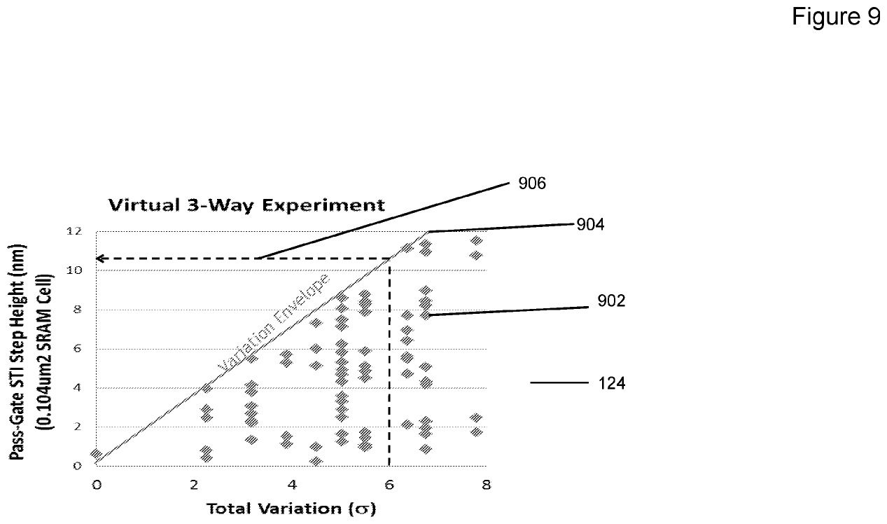

FIG. 9 depicts an exemplary 2D X-Y graphical plot display of virtual metrology data generated by a virtual experiment. In the example depicted in FIG. 7, the total variation in shallow trench isolation (STI) step height due to varying 3 parameters in preceding steps of the process sequence is shown. Each diamond 902 represents a virtual fabrication run. The variation envelope 904 is also displayed as is the depicted conclusion 906 that the downstream process modules must support approximately 10.5 nm of total variation in STI step height to achieve robustness through 6 sigma of incoming variation. The virtual experiment results can also be displayed in multi-dimensional graphic formats.

Once the results of the virtual experiment have been assembled, the user can review 3D models that have been generated in the 3D viewer (step 614a) and review the virtual metrology measurement data and metrics presented for each virtual fabrication run (step 614b). Depending on the purpose of the virtual experiment, the user can analyze the output from the 3D modeling engine for purposes of developing a process sequence that achieves a desired nominal structural model, for further calibrating process step input parameters, or for optimizing a process sequence to achieve a desired process window.

The 3D modeling engine's 75 task of constructing multiple structural models for a range of parameter values (comprising a virtual experiment) is very compute intensive and therefore could require a very long time (many days or weeks) if performed on a single computing device. To provide the intended value of virtual fabrication, model building for a virtual experiment must occur many times faster than a physical experiment. Achieving this goal with present day computers requires exploiting any and all opportunities for parallelism. The 3D modeling engine 75 of the present invention uses multiple cores and/or processors to perform individual modeling steps. In addition, the structural models for different parameter values in a set are completely independent and can therefore be built in parallel using multiple cores, multiple processors, or multiple systems.

3D modeling engine 75 may represent the underlying structural model using a voxel-based implicit geometry representation. Voxels are the 3D equivalent of 2D picture elements, or pixels. Each voxel is a cube, all of them having the same lateral dimension, and may contain one or more materials, or no materials. An implicit geometry representation is one in which the interface between materials in the 3D structural model is defined without an explicit representation of the (x,y,z) coordinate locations of that interface. Many of the operations performed by the 3D modeling engine are voxel modeling operations. Modeling operations based on a digital voxel representation are far more robust than the corresponding operations in a conventional solid modeling kernel (e.g. a Constructive Solid Geometry-based (CSG) solid modeling kernel). Such CSG solid modeling operations are generally not suitable to model many aspects of semiconductor structural modeling including the very thin layers produced by deposition processes and the propagation of etch fronts which may result in topological changes including the merging of surfaces and/or fragmentation of the solid model.

Some simulation tools require a volume mesh to be generated from some form of explicit boundary representation and previous solutions exist for creating a volume mesh from B-rep geometry from surface meshes. Such volume meshes for finite-element or finite-volume simulation techniques will preserve the location of the interface between materials to a high level of accuracy. Such a volume mesh is called a boundary-conforming mesh or simply a conformal mesh. A key feature of such a mesh is that no element crosses the boundary between materials. In other words, for a volume mesh of tetrahedral elements, each element is wholly within one material and thus no tetrahedron contains more than one material. However, neither B-rep and similar solid modeling kernels, nor surface mesh representations are optimal for virtual fabrication. Solid modeling kernels, for example, are not setup to represent common virtual fabrication operations such as the movement of an interface or the growth of a deposited material. Geometry representations that instead represent the boundaries implicitly do not suffer from these problems. A virtual fabrication system that uses an implicit representation exclusively thus has significant advantages since its modeling operations are rooted in mathematical expressions that represent the real fabrication process.

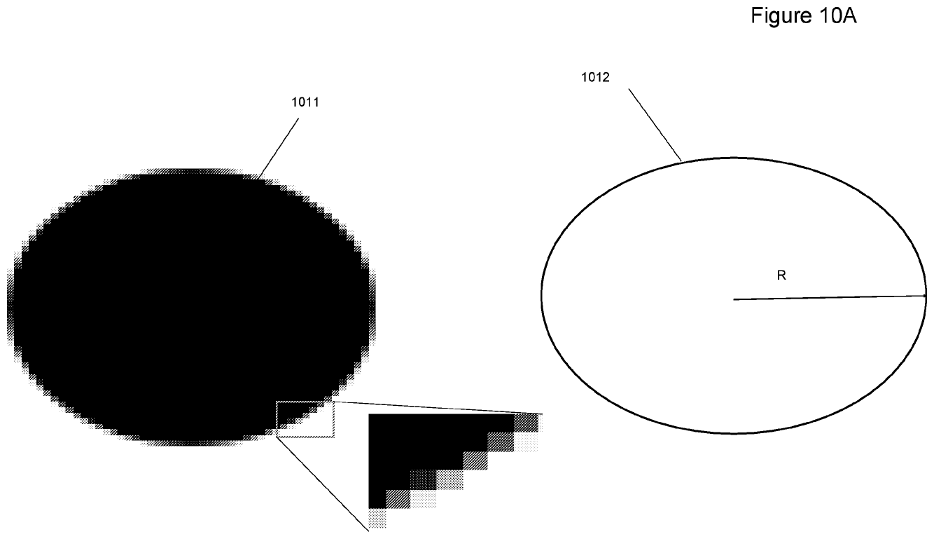

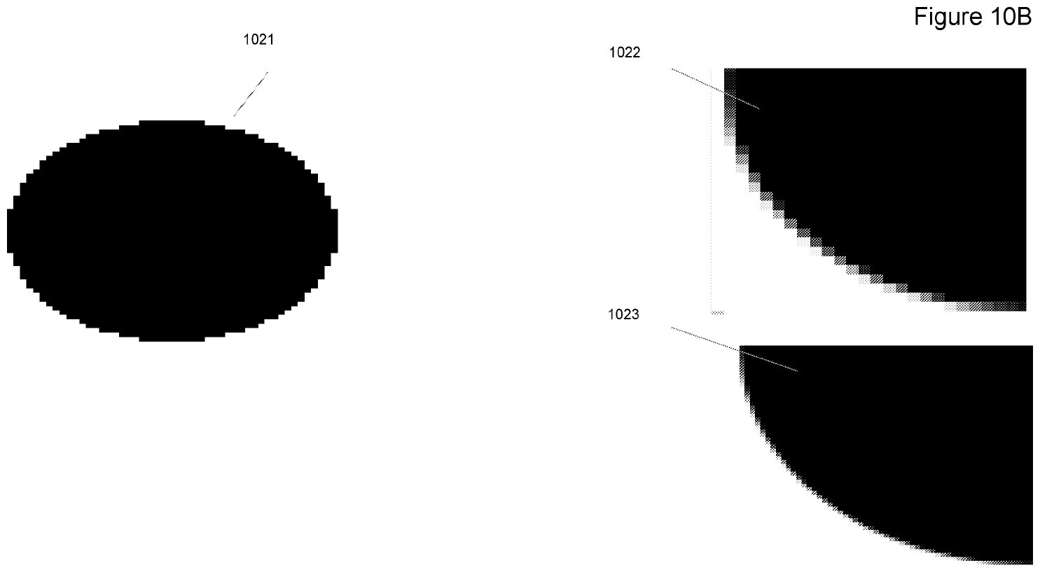

Voxels together with their fill-fractions can implicitly represent the interface between materials. FIG. 10A illustrates this concept in two dimensions for a disk. The equivalent to a voxel in two dimensions is a pixel, but the term voxel will be used instead to illustrate the comparison. A B-rep representation 1012 may represent the disk as the equation of a circle with radius R with material 1 inside the circle and material 2 outside. In contrast, a voxel representation of the disk 1011 is an array of squares where each square stores material identification numbers within it, and the relative amounts of each material. The relative darkness of the squares in 1011 indicates the relative percentage of material 1 versus material 2. Black indicates 100% material 1 and 0% material 2, and white indicates 0% material 1 and 100% material 2. Since the circle cuts through several voxels along its path, these voxels on the boundary of the disk have shades of gray indicating their fill fractions. Partially filled voxels indicate that the boundary crosses this voxel, but does not indicate where and its orientation. The fill fractions of a boundary voxel and others in its neighborhood may be used to determine the boundary explicitly.

Material properties at a location within the geometry may be approximated using the properties of the majority material within each voxel. For instance, in an operation to determine electrical resistance if a boundary voxel is more than 50% of material 2 in circle 1011, then the bulk resistivity of material 2 may be assigned to this voxel, and similarly voxels of 50% or more of material 1 will be assigned the bulk resistivity of material 1. This is equivalent to filling each voxel with its majority or dominant material as shown in FIG. 10B, circle 1021. This approach incurs what is called ‘staircasing’ error in the representation of a boundary. One method to compensate for staircasing error is to decrease the size of each voxel when performing the virtual fabrication of the 3D model which reduces the volume of boundary voxels. For instance, circle portion 1022 is part of the circle of the voxel representation in 1011, and circle portion 1023 is the same part of the circle built with voxels one half of the size in each dimension. The volume occupied by boundary voxels decreases with voxel size and thus the error.

Deformation and Stress Analysis Modeling

Predicting deformation and stress on structures formed during the fabrication of integrated circuits, from the nanometer scale of a semiconductor device to the macroscopic scale of a wafer, is of great importance to the semiconductor industry. Deformation and stress analysis modeling may be used to predict device performance due to stress effects, to determine stress from film patterning and thermal budgets, to determine stress accumulation and relaxation during stack patterning, to manage deformation of high-aspect ratio structures due to process conditions and to correct process-induced overlay errors, among other uses.

Structural deformation and stress in semiconductor fabrication can be simulated using thermoelasticity theory. Residual stress effects can also be incorporated in the theory. The Finite Element Method (FEM) has been the most common approach for performing stress analysis. FEM enables accurate computation of both displacement and stress fields. However, FEM requires the generation of a mesh from the device model that conforms to the material interfaces (“conformal mesh”). Robust and automatic mesh generation with optimal guarantees on the shape of the generated elements, which is a requirement for numerical computations, is sometimes difficult to attain. Further, mesh generation is also computationally expensive and can be much slower than the generation of the virtual device model.

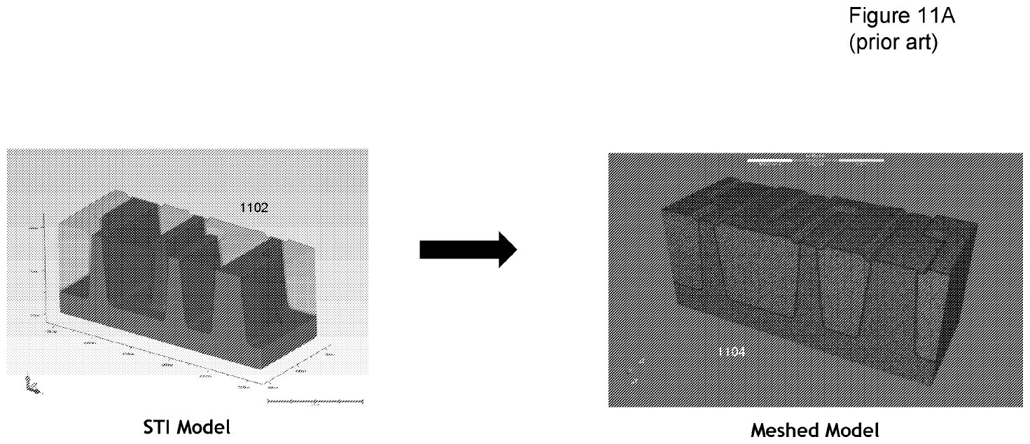

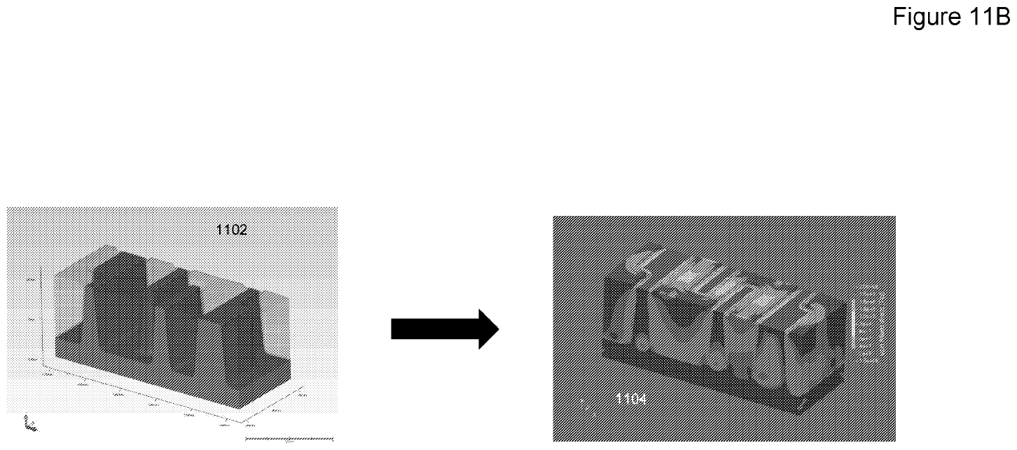

An example of a conventional approach to perform stress analysis is seen in FIG. 11 (prior art) which depicts an exemplary 3D structural model 1102 of a Shallow Trench Isolation (STI) feature and a corresponding mesh 1104 generated from the model. In this example, the 3D structural model may be produced by simulating in the virtual fabrication environment twenty-one process steps that may take two hundred seconds to complete. To generate the conformal mesh 1104 from the 3D structural model 1102 however may require an additional twenty five hundred seconds to produce a mesh with 5 million nodes, or twelve and a half times longer than it took to create the model. Once produced, this mesh may be used to perform FEM for stress analysis. This example highlights two difficulties with conventional techniques. Mesh generation may take a long time to complete making the analysis computationally expensive even for a single point in the process sequence. In addition, the process sequences common in the fabrication of semiconductor device structures can include hundreds of steps during which the geometry is greatly modified. These structural modifications lead to changes to stress fields which is of interest to process engineers. Thus the process of mesh generation, analysis and incorporation of the solution on a new process step is both laborious for the analyst to setup and computationally expensive to execute.

Embodiments of the present invention address these issues by enabling a virtual fabrication environment to accurately model and compute deformation and stress fields for three-dimensional structural models. This may be accomplished with a two-pronged approach that allows the user to first construct a model of the fabrication process as it evolves to create a detailed representation of the space occupied by the different materials in the process and secondly to directly operate on this model to calculate the deformation and stress fields. As explained further below, embodiments enable the calculation of the deformation and stress fields to take place without first generating a conformal mesh of the model and without having to exit the virtual fabrication environment. This integration of the stress analysis within the virtual fabrication environment enables sensitivity analysis/parametric studies to be conducted within the virtual fabrication environment thus providing a process integration engineer with information to optimize the fabrication process.

As noted above, a virtual fabrication environment may use a voxel-based modeling approach to create a 3D model of a semiconductor device structure being virtually fabricated. The voxels associated with the model identify one or more materials and include the fill-fractions of materials in each voxel. The material interface locations, although only known implicitly, may be reconstructed as part of a voxel grid that represent the device structure. For example, in one embodiment, the interfaces between different materials may be identified based on volume fraction data of voxels in the voxel grid.

Embodiments of the present invention directly use the information in the voxel grid to perform deformation and stress analysis without first having to create a conformal mesh and without having to leave the virtual fabrication environment. For example, each voxel on the grid contains the materials present in the voxel together with their volume fraction. By analyzing the voxels in its neighborhood, information about the interface can be obtained. This information is sufficient to create a local approximation to the interface and from this the approximation functions used by the underlying numerical scheme which guarantee optimal properties of the solution algorithm. This direct use of the voxel grid information results in significant time savings and ease of operation by the user. For example, as depicted in FIG. 11B, for the STI model 1102 of FIG. 11A, the performance of stress analysis directly using the voxel grid information enables the creation of a stress analysis model with 20 million nodes (four times as many nodes as in the conformal mesh) with a 30% time savings versus producing the conformal mesh (1750 seconds versus 2500 seconds). Further, this stress analysis takes place within the virtual fabrication environment and this integration of the deformation and stress analysis into the virtual fabrication environment enables the results of the analysis to be quickly and accurately used to optimize additional process designs used to fabricate the semiconductor device structure of interest.

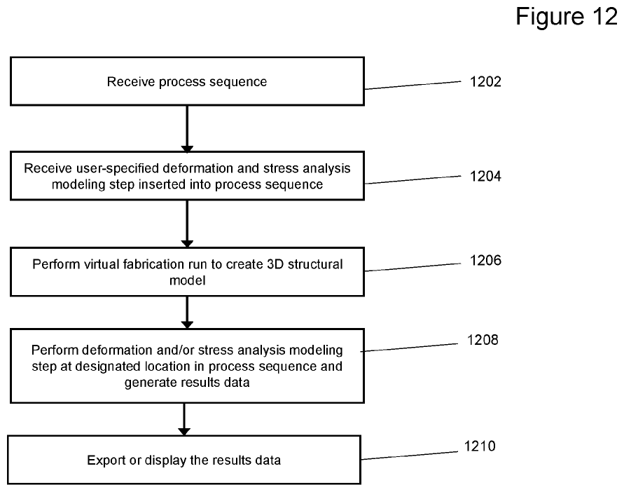

FIG. 12 depicts an exemplary sequence of steps performed in the virtual fabrication environment to perform deformation and stress analysis modeling in an exemplary embodiment. The sequence begins by receiving in a virtual fabrication environment a selection of a process sequence (step 1202). An indication of an insertion of a user-specified deformation and stress analysis modeling step into the process sequence is also received via a graphical user interface in the virtual fabrication environment (step 1204). As used herein, the term “deformation and stress analysis step” means a step inserted into a process sequence that when executed in the virtual fabrication environment performs stress analysis, deformation analysis or measurement, or both. For example the deformation and stress analysis step may correspond to the deposition of a layer of material onto a complex structure held at some temperature, with a subsequent cool off operation. The different modulii, coefficients of thermal expansion, and the change in temperature will cause a rearrangement of the stress field to satisfy equilibrium. A virtual fabrication run is performed using the process sequence and generates a 3D structural model based on the execution of the process sequence (step 1206). The deformation and stress analysis modeling step is performed at the indicated position in the process sequence and generates results data (step 1208). The results data is exported or displayed (step 1210).

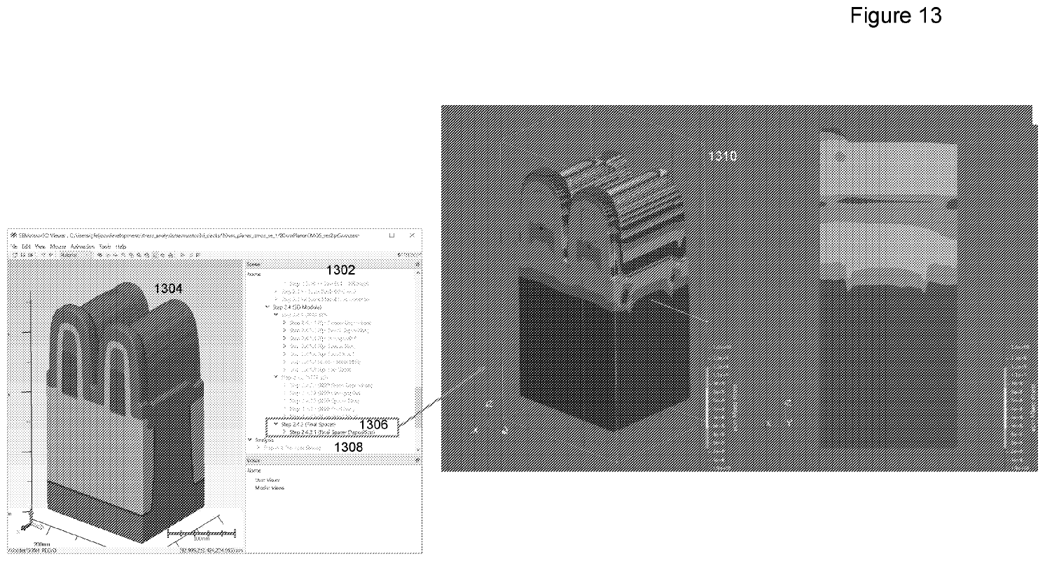

The results of the deformation and stress analysis step may be displayed to a user via a three dimensional view of the structural model provided by the virtual fabrication environment. For example, FIG. 13 displays a graphical user interface depicting the results of a stress analysis step 1308 performed at the end of a process sequence 1302 used to create an STI structural model 1304 in an exemplary embodiment. More particularly, the stress analysis step 1308 has been requested by a user to take place after the final spacer step 2.4.3 (1306) in the fabrication of the STI feature. Color-coded results of the stress analysis step 1308 (indicating von Mises stress field) following the final spacer step 2.4.3 (1306) in the process sequence 1302 may be graphically depicted in a view 1310 of a 3D model.

While the performance of stress analysis at a single point in the process sequence is useful, it is sometimes more relevant and/or more accurate to be able to predict how the stress fields evolve during the process sequence as earlier steps affect later steps. Embodiments enable a user to insert multiple stress analysis and deformation measurement (stress metrology) steps at multiple points in the process sequence. The stress analysis steps allow the user to perform simulations of the deformation of a semiconductor structure and compute both the deformation and stress fields due to parameters such as the operating temperature of the process, material parameters, and previous state of deformation.

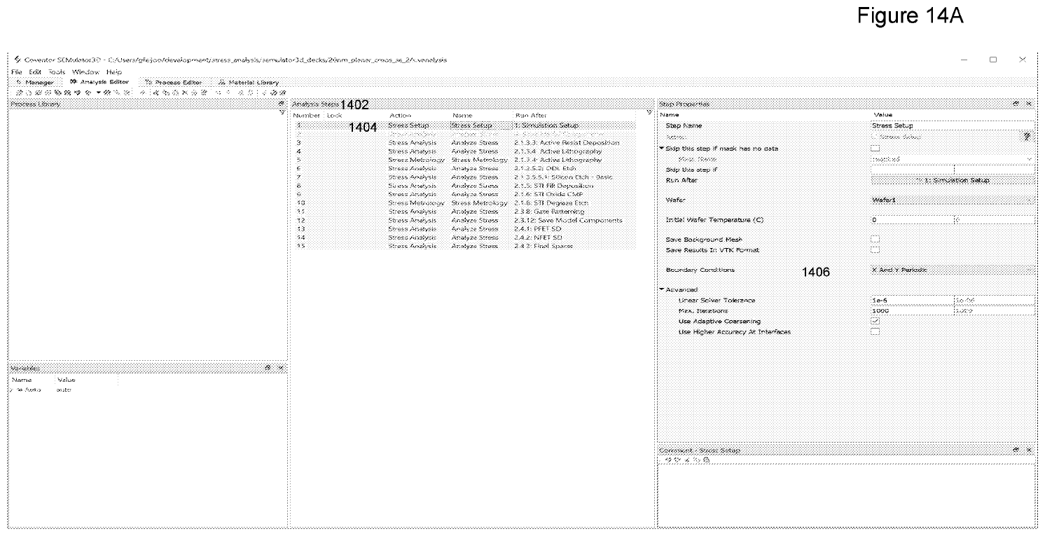

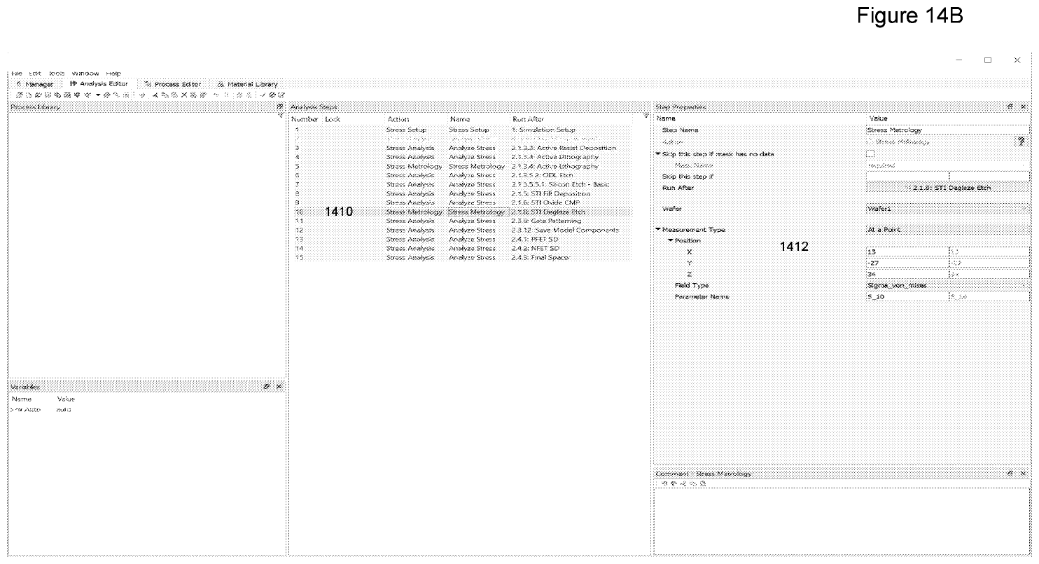

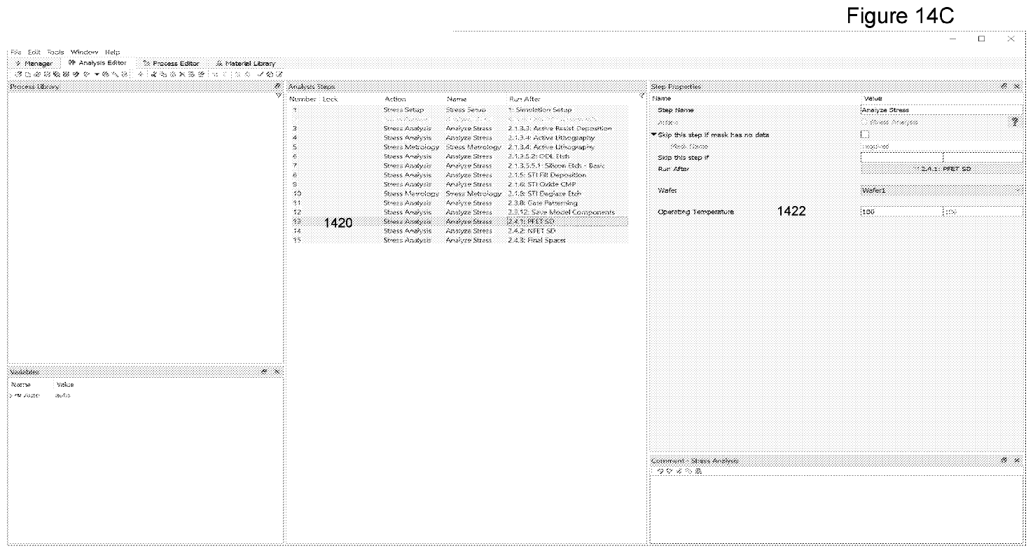

FIGS. 14A-14C depict exemplary user interfaces in exemplary embodiments suitable for adding deformation and stress analysis modeling steps to a process sequence and for selecting associated parameters for the deformation and stress analysis modeling operations. FIG. 14A depicts a graphical user interface displaying a list 1402 of fifteen separate stress analysis steps added by a user to various locations in a process sequence in an exemplary embodiment. The list 1402 includes an initial stress setup step 1404 which contains common properties of the overall stress analysis and user-selected boundary conditions 1406 for the analysis. In one embodiment, a user may select an adaptive coarsening parameter as part of the initial stress setup step 1404. With adaptive coarsening, instead of being uniform, the voxel grid is coarsened away from the interfaces to increase the size of the voxels and lessen computational requirements.

FIG. 14B depicts a graphical user interface displaying a user deformation measurement (“stress metrology”) step 1410 inserted in a process sequence in an exemplary embodiment. The stress metrology step 1410 includes user selectable parameters including a position 1412 in the structural model for the virtual metrology measurement of a deformed structure to take place.

FIG. 14C depicts a graphical user interface displaying a stress analysis step 1420 inserted in a analysis sequence in an exemplary embodiment. The stress analysis step 1420 includes user selectable parameters including the operating temperature 1422 under which the analysis should be conducted.

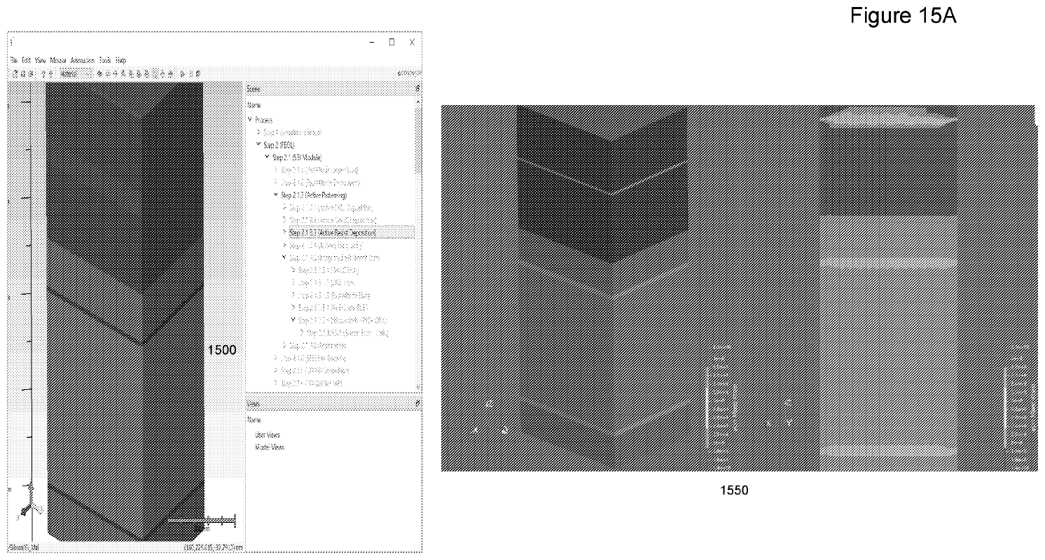

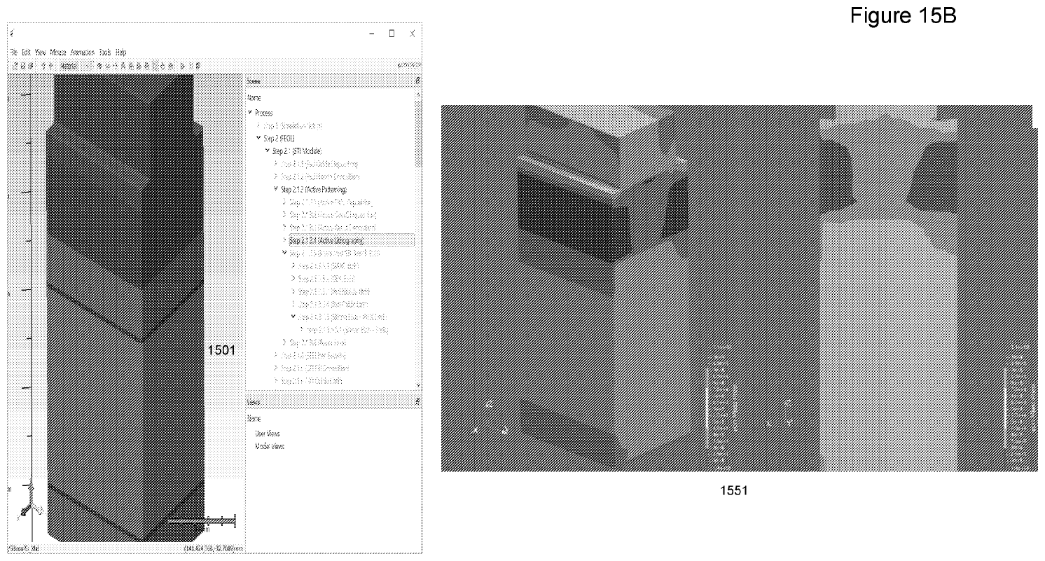

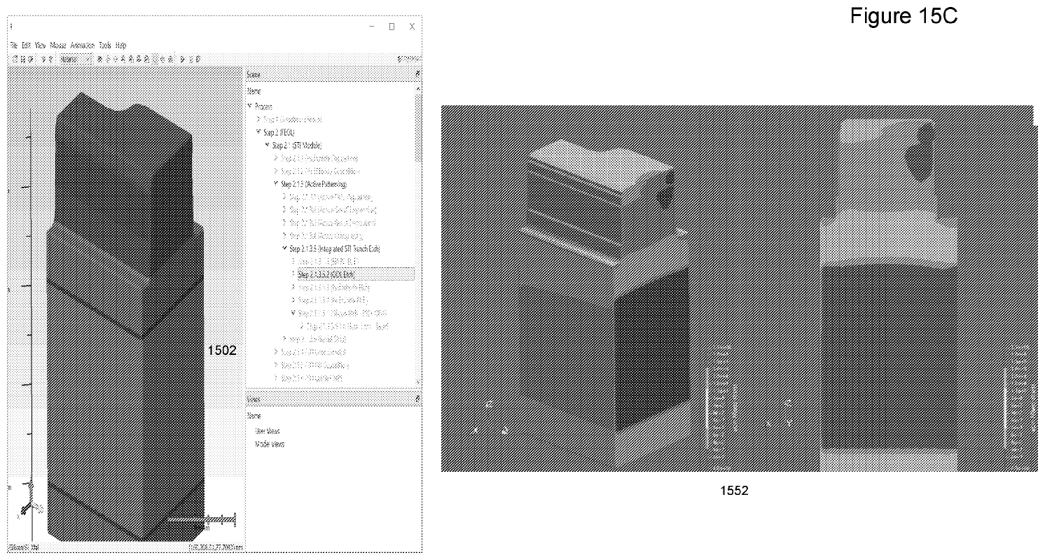

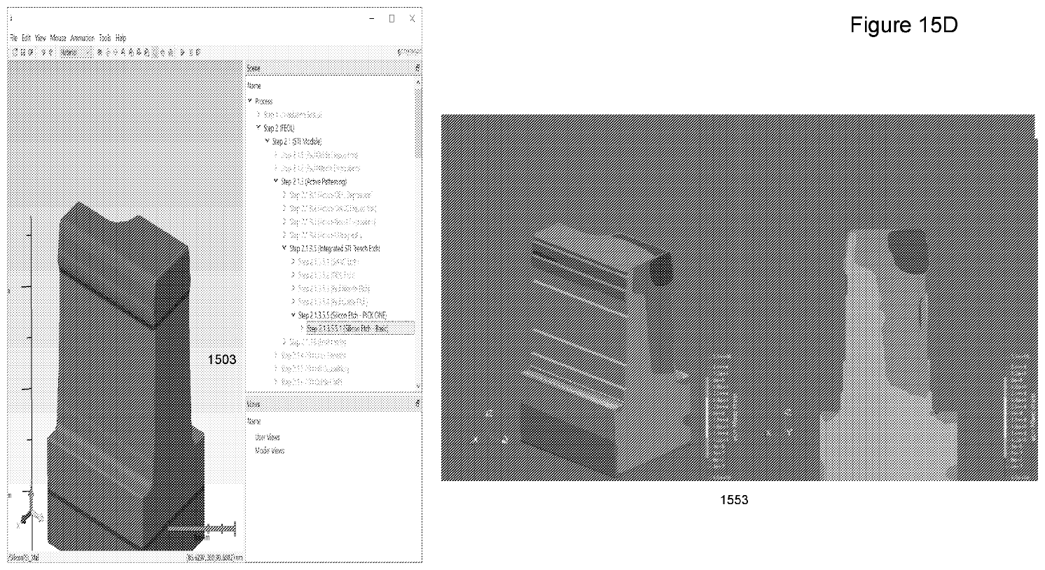

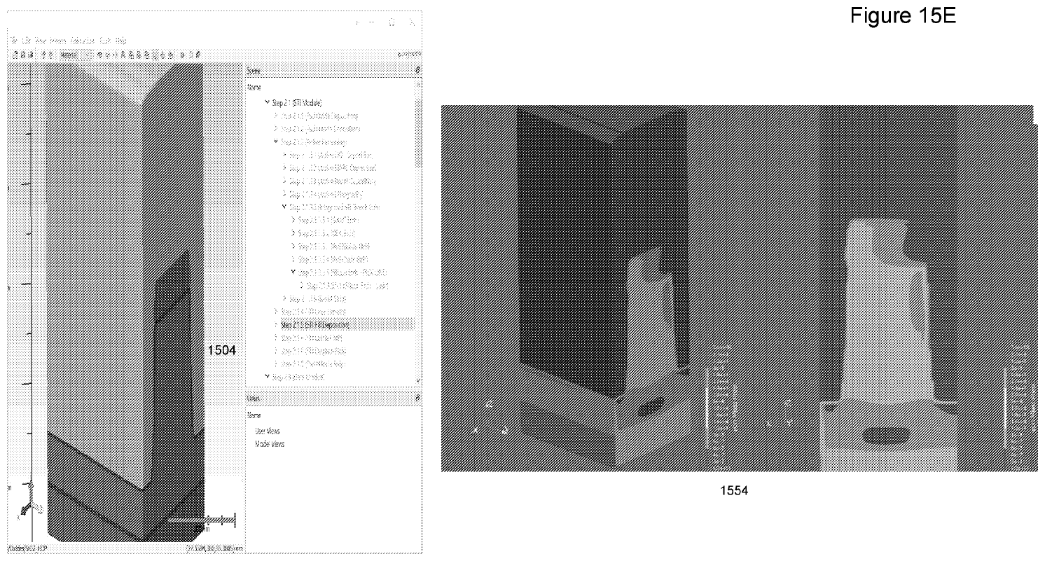

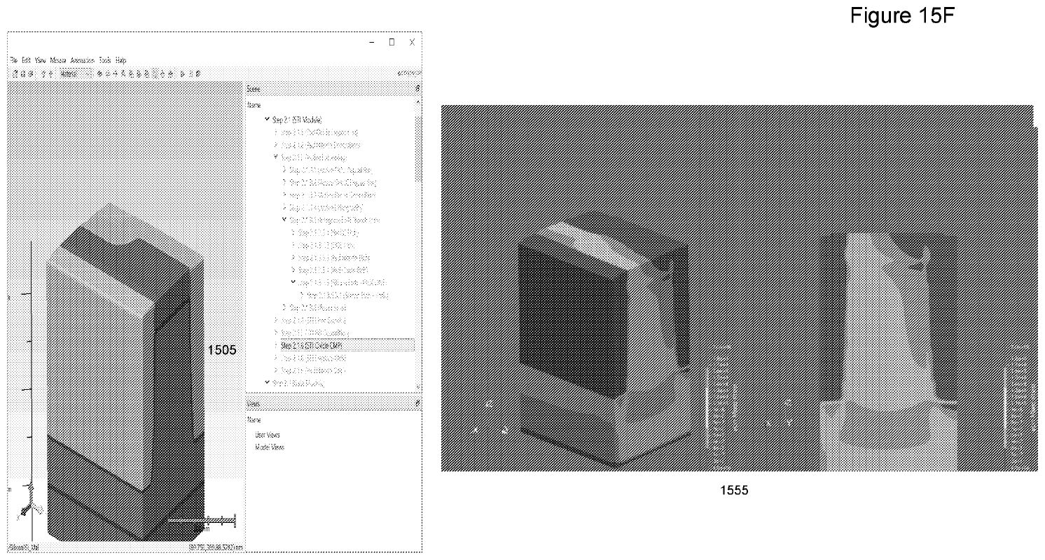

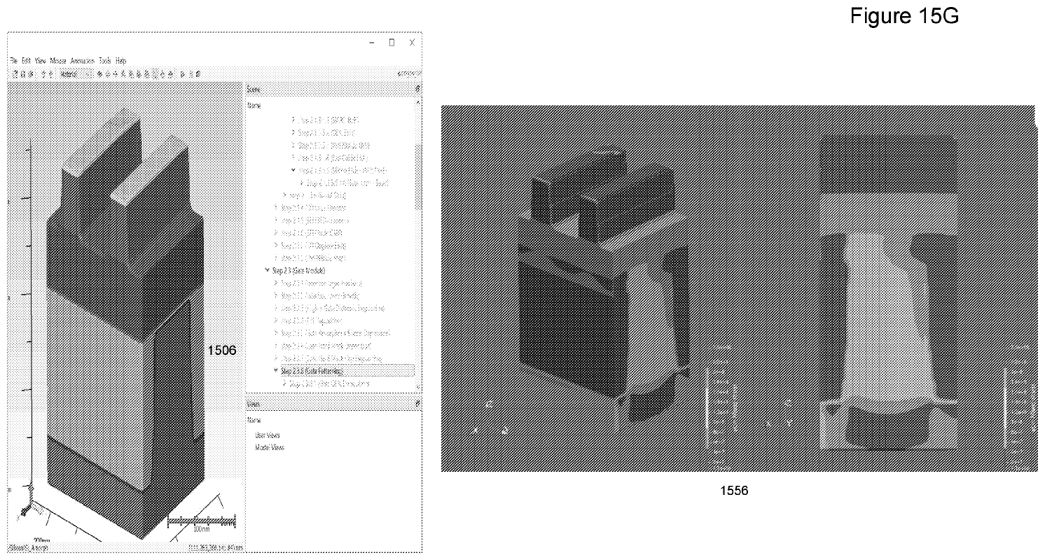

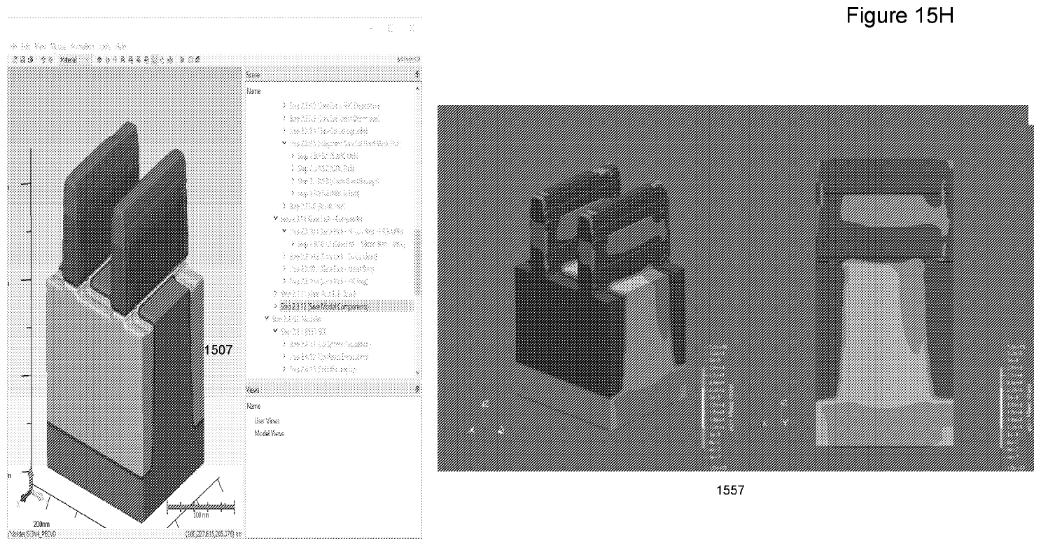

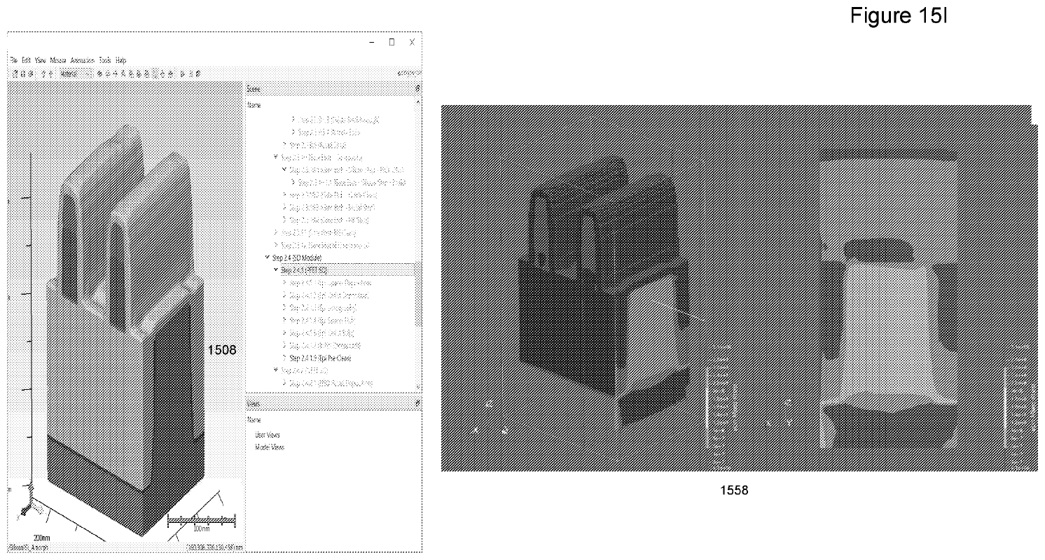

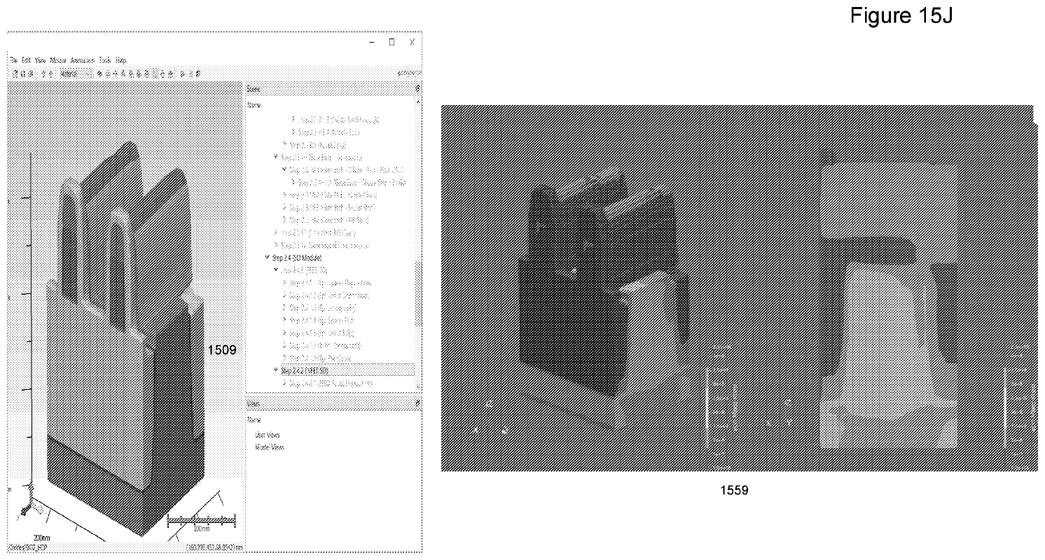

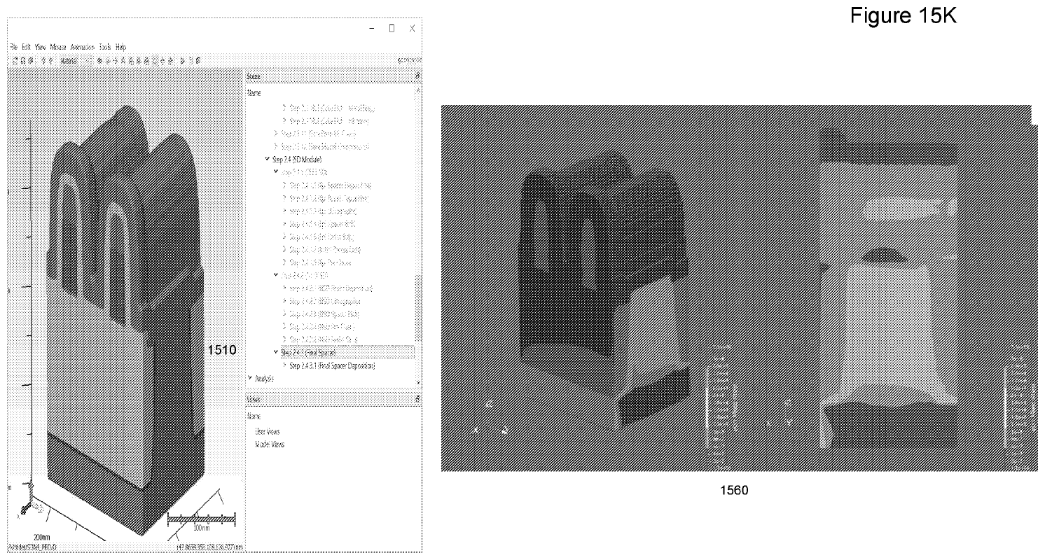

FIGS. 15A-15K depict exemplary graphical user interfaces provided by the virtual fabrication environment depicting the evolution of stress fields for an STI feature of interest in an exemplary embodiment. More particularly, the left side of FIGS. 15A-15K depict 3D views of the evolution the 3D structural model 1500-1510 during execution of the process sequence while the right side of FIGS. 15A-15K depict 3D views of the corresponding evolution of the stress fields 1550-1560 for the STI feature.

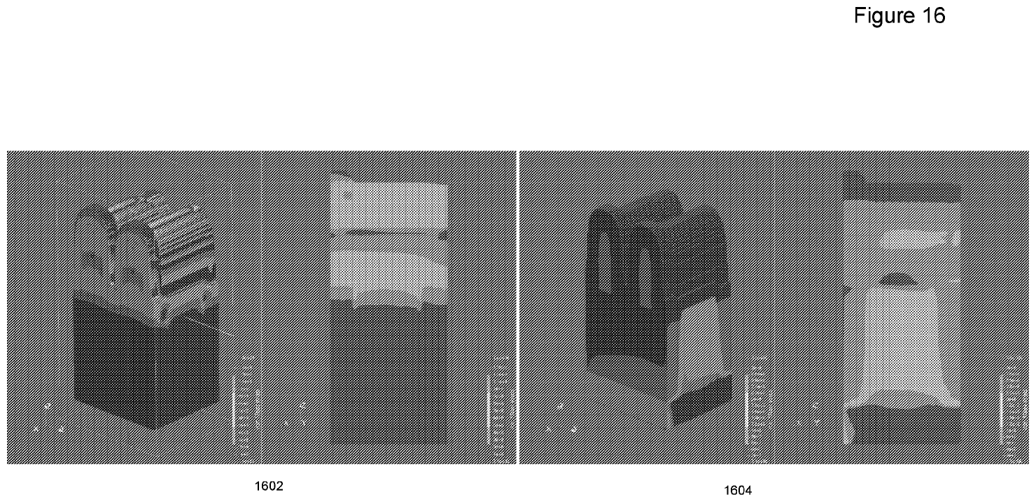

FIG. 16 depicts side by side views of a single stress analysis result 1602 and an evolved stress field 1604 after the final spacer step for fabrication of the STI feature in exemplary embodiments.

Portions or all of the embodiments of the present invention may be provided as one or more computer-readable programs or code embodied on or in one or more non-transitory mediums. The mediums may be, but are not limited to a hard disk, a compact disc, a digital versatile disc, a flash memory, a PROM, a RAM, a ROM, or a magnetic tape. In general, the computer-readable programs or code may be implemented in any computing language.

Since certain changes may be made without departing from the scope of the present invention, it is intended that all matter contained in the above description or shown in the accompanying drawings be interpreted as illustrative and not in a literal sense. Practitioners of the art will realize that the sequence of steps and architectures depicted in the figures may be altered without departing from the scope of the present invention and that the illustrations contained herein are singular examples of a multitude of possible depictions of the present invention.

The foregoing description of example embodiments of the invention provides illustration and description, but is not intended to be exhaustive or to limit the invention to the precise form disclosed. Modifications and variations are possible in light of the above teachings or may be acquired from practice of the invention. For example, while a series of acts has been described, the order of the acts may be modified in other implementations consistent with the principles of the invention. Further, non-dependent acts may be performed in parallel.

We claim:

1. A non-transitory medium holding computer-executable instructions for performing deformation and stress analysis modeling in a virtual fabrication environment, the instructions when executed causing at least one computing device to:
receive a selection of a process sequence in a process editor for a semiconductor device structure to be virtually fabricated;
receive a user-specified deformation and stress analysis modeling step inserted into the process sequence, the deformation and stress analysis modeling step indicating a designated point during the process sequence for deformation and stress analysis modeling to be performed;
perform with the computing device a virtual fabrication run that models an integrated process flow used to physically fabricate the semiconductor device structure by using the process sequence and 2D design data to simulate patterning, material addition and/or material removal steps performed to physically fabricate the semiconductor device structure, the virtual fabrication run:
executing the process sequence up until the deformation and stress analysis modeling step, the executing building a 3D structural model of the semiconductor device structure, the 3D structural model predictive of a result of a physical fabrication of the semiconductor device structure, and
performing the deformation and stress analysis modeling step, the deformation and stress analysis modeling step generating result data; and
output the result data generated from the deformation and stress analysis modeling step.

2. The medium of claim 1 wherein the result data is displayed in a 3D graphical view of the 3D structural model.

3. The medium of claim 1 wherein the instructions when executed cause the at least one computing device to:
receive a plurality of deformation and stress analysis steps at designated locations in the process sequence; and
generate a plurality of result data for the plurality of deformation and stress analysis steps.

4. The medium of claim 3 wherein the plurality of result data is displayed in a 3D graphical view of the 3D structural model.

5. The medium of claim 1, wherein the 3D structural model is a voxel-based model that uses an implicit geometry representation that includes a plurality of voxels arranged in a voxel grid and the deformation and stress analysis modeling step performs:
identification of interfaces between different materials in the plurality of voxels based on volume fraction data for each voxel.

6. The medium of claim 5, wherein the deformation and stress analysis modeling step performs a coarsening operation on the voxel grid.

7. The medium of claim 6, wherein the coarsening operation is an adaptive coarsening operation where the voxel grid is coarsened away from material interfaces.

8. A computing device-implemented method for performing deformation and stress analysis modeling in a virtual fabrication environment, comprising:
receiving a selection of a process sequence in a process editor for a semiconductor device structure to be virtually fabricated, the process sequence including a user-specified deformation and stress analysis modeling step, the deformation and stress analysis modeling step indicating a point during the process sequence for deformation and stress analysis modeling to be performed;
performing with the computing device a virtual fabrication run that models an integrated process flow used to physically fabricate the semiconductor device structure by using the process sequence and 2D design data to simulate patterning, material addition and/or material removal steps performed to physically fabricate the semiconductor device structure, the virtual fabrication run:
executing the process sequence up until the deformation and stress analysis modeling step, the executing building a 3D structural model of the semiconductor device structure, the 3D structural model predictive of a result of a physical fabrication of the semiconductor device structure, and
performing the deformation and stress analysis modeling step, the deformation and stress analysis modeling step generating result data; and
outputting the result data generated from the deformation and stress analysis modeling step.

9. The method of claim 8 wherein the result data is displayed in a 3D graphical view of the 3D structural model.

10. The method of claim 8, further comprising:
receiving a plurality of deformation and stress analysis steps at designated locations in the process sequence; and
generating a plurality of result data for the plurality of deformation and stress analysis steps.

11. The method of claim 8 wherein the plurality of result data is displayed in a 3D graphical view of the 3D structural model.

12. The method of claim 8 wherein the 3D structural model is a voxel-based model that uses an implicit geometry representation that includes a plurality of voxels arranged in a voxel grid and further comprising:
identifying interfaces between different materials in the plurality of voxels based on volume fraction data for each voxel.

13. The method of claim 12, wherein the deformation and stress analysis modeling step performs a coarsening operation on the voxel grid.

14. The method of claim 13, wherein the coarsening operation is an adaptive coarsening operation where the voxel grid is coarsened away from material interfaces.

15. A system for performing deformation and stress analysis modeling in a virtual fabrication environment, comprising:
at least one computing device equipped with one or more processors and configured to generate a virtual fabrication environment that includes a deformation and stress analysis modeling module, the deformation and stress analysis modeling module when executing:
receiving a selection of a process sequence in a process editor for a semiconductor device structure to be virtually fabricated, the process sequence including a user-specified deformation and stress analysis modeling step, the deformation and stress analysis modeling step indicating a point during the process sequence for deformation and stress analysis modeling to be performed;
performing with the computing device a virtual fabrication run that models an integrated process flow used to physically fabricate the semiconductor device structure by using the process sequence and 2D design data to simulate patterning, material addition and/or material removal steps performed to physically fabricate the semiconductor device structure, the virtual fabrication run:
executing the process sequence up until the deformation and stress analysis modeling step, the executing building a 3D structural model of the semiconductor device structure, the 3D structural model predictive of a result of a physical fabrication of the semiconductor device structure, and
performing the deformation and stress analysis modeling step, the deformation and stress analysis modeling step generating result data; and
a display in communication with the at least one computing device, the display configured to display the result data from the deformation and stress analysis modeling step.

16. The system of claim 15 wherein the result data is displayed in a 3D graphical view of the 3D structural model.

17. The system of claim 15 wherein the deformation and stress analysis modeling module:
receives a plurality of deformation and stress analysis steps at designated locations in the process sequence; and
generates a plurality of result data for the plurality of deformation and stress analysis steps.

18. The system of claim 17 wherein the plurality of result data is displayed in a 3D graphical view of the 3D structural model.

19. The system of claim 15, wherein the 3D structural model is a voxel-based model that uses an implicit geometry representation that includes a plurality of voxels arranged in a voxel grid and the deformation and stress analysis modeling step performs:
identification of interfaces between different materials in the plurality of voxels based on volume fraction data for each voxel.

20. The system of claim 19, wherein the deformation and stress analysis modeling step performs a coarsening operation on the voxel grid.
